(19) United States
(12) Patent Application Publication
(10) Pub. No.: US 2011/0154007 A1
(43) Pub. Date: Jun. 23, 2011

(54) Low energy boot options for devices

(75) Inventor: Anssi M. Juvonen, Karjaa (FI)

(73) Assignee: Nokia Corporation

(21) Appl. No.: 12/655,222

(22) Filed: Dec. 23, 2009

(51) Int. Cl. G06F 1/28; G06F 9/24

(52) U.S. Cl. 713/2; 713/340

(57) ABSTRACT

A method includes determining an amount of energy in a consumable energy source, such as a battery, that forms part of a device. The method further includes facilitating selection of a next software boot mode for the device from a plurality of possible software boot modes based at least on the determined amount of energy in the consumable energy source. The next software boot mode can be, by example, one of booting a reduced energy user interface enabling the composition and storage of at least one message, booting a reduced energy user interface with a communication protocol stack enabling the composition and transmission of at least one message, and booting a communication protocol stack enabling the transmission of at least one stored message.

### TECHNICAL FIELD

The exemplary and non-limiting embodiments of this invention relate generally to devices, including devices associated with communication systems, methods and computer programs and, more specifically, relate to devices, such as communication devices, powered by a consumable energy source such as a battery.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

Modern portable devices, such as wireless communication devices (e.g., cellular phones), typically include one or more powerful computer systems that execute an operating system. A problem that arises concerns the ability to execute the operating system and related functionality when the power source, typically a battery at present, is in a discharged or nearly discharged state.

### SUMMARY

The foregoing and other problems are overcome, and other advantages are realized, in accordance with the exemplary embodiments.

In one aspect thereof the exemplary embodiments provide a method comprising determining an amount of energy in a consumable energy source that comprises part of a communication device; and facilitating selection of a next software boot mode for the device from a plurality of possible software boot modes based at least in part on the determined amount of energy in the consumable energy source.

In another non-limiting aspect thereof the exemplary embodiments provide an apparatus that comprises at least one processor and at least one memory including computer program code. The at least one memory and the computer program code are configured to, with the at least one processor, cause the apparatus at least to perform determine an amount of energy in a consumable energy source of a device; and facilitate selection of a next software boot mode for the device from a plurality of software boot modes based at least in part on the determined amount of energy in the consumable energy source.

In a further non-limiting aspect thereof the exemplary embodiments provide a computer-readable memory medium that stores computer program instructions, where execution of the computer program instructions by at least one data processor results in a performance of operations that comprise determining an amount of energy in a consumable energy source of a device; and facilitating selection of a next software boot mode for the device from a plurality of software boot modes based at least in part on the determined amount of energy in the consumable energy source.

### BRIEF DESCRIPTION OF THE DRAWINGS

The foregoing and other aspects of the exemplary embodiments are made more evident in the following Detailed Description, when read in conjunction with the attached Drawing Figures, wherein:

FIG. 1 is simplified block diagram of a wireless communication device that is one embodiment of a device in which the exemplary embodiments can be used.

FIG. 2 is a simplified block diagram that further illustrates the device shown in FIG. 1.

FIG. 3 is a diagram that shows battery charge thresholds and various boot mode threshold/trigger points that are the implemented by the boot selector/loader block shown in FIG. 2.

FIG. 4 is a logic flow diagram that illustrates the operation of a method, and a result of execution of computer program instructions, in accordance with the exemplary embodiments.

FIGS. 5 and 6 are logic flow diagrams that each illustrate the operation of a method, and a result of execution of computer program instructions, to facilitate selection of a next default boot mode when the device is in a running state, and when the device is in a boot-up state (at boot time), respectively.

### DETAILED DESCRIPTION

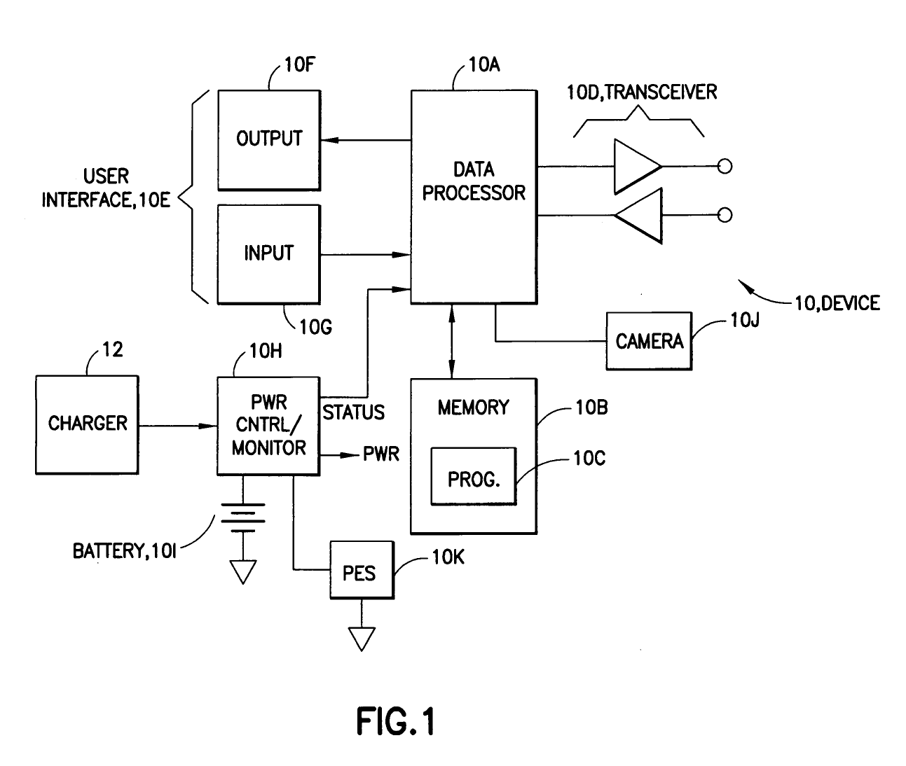

FIG. 1 shows a device 10 that comprises all or part of an apparatus. The device 10 includes a controller, such as at least one computer, microcomputer, microcontroller or simply a data processor 10A, and a computer-readable memory medium embodied as at least one memory 10B that stores a program of computer instructions (PROG) 10C. The device 10 can also include at least one suitable wireless (e.g., cellular) transceiver 10D for bidirectional wireless communications with a wireless network access node, such as a base station or Node B or evolved Node B (not shown), via one or more antennas (not shown). The transceiver 10D may be operable with any type of long range or short range radio frequency or optical air interface, including one or more of time divisional multiple access, code division multiple access, wideband code division multiple access, and orthogonal frequency division multiple access air interfaces, as non-limiting embodiments. The device 10 also includes a user interface 10E having a user output 10F, such as a visual display and/or a voice synthesis function, and a user input 10G, such as a keypad, keyboard, pointing device, touch screen, biometric and/or voice recognition system, as non-limiting examples.

The program 10C can be assumed to include software instructions implementing routines and code modules providing for a main operating system (OS) and other programs needed to operate the device 10, such as (but not limited to) wireless communication programs including implementation of a cellular protocol stack (if the device 10 is embodied in a cellular phone), programs to compose messages based on user inputs from the user interface 10E, programs configured to transmit a composed message via the transceiver 10D, programs to display or otherwise present information to the user, as well as programs configured to implement the exemplary embodiments as described in detail below. The device 10 can include an image capture device, embodied as a digital camera 10J, and may include multimedia capabilities (e.g., an ability to send and/or receive images and/or audio recorded via a microphone (not shown)).

The device 10 further includes a power control/monitoring (PWR CNTRL/MONITOR) functional block 10H configured with a consumable energy source, such as a battery 10I. The consumable energy source may, in other embodiments, include a fuel cell and/or a supercapacitor, as two non-limiting examples. The PWR CNTRL/MONITOR functional block 10H is also configured to receive energy from an external energy source 12 such as, but not limited to, a charger, a powered communication interface such as Universal Serial Bus (USB) or Power over Ethernet (PoE), and/or the like. Such a powered communication interface may enable a boot mode where the operating system and/or other functionality to be booted is retrieved to the device 10 from, and/or communicates with, an external device, optionally over a connection to a network such as the Internet. In such a scenario, it may be possible to use the device 10 as a thin client to network communication systems, services and protocols, e.g., e-mail functionality as an alternative or addition to the communication functionality built in the device. The external energy source may be configured to operate directly or by an induction from a power main, or from one or more solar cells, or from any source of electrical or optical or chemical energy. The external energy source 12 may be connected via any suitable means, including a micro-USB charger connector. The PWR CNTRL/MONITOR functional block 10H, which may be embodied in an integrated circuit or module, functions to provide by itself or in cooperation with other circuitry operating power (PWR) to the device 10 using energy received from the battery 10I or the external energy source 12. The PWR CNTRL/MONITOR functional block 10H also provides at least one indication or status signal to the data processor 10A for informing the data processor 10A of the status of the battery 10I (e.g., fully charged, partially charged, substantially discharged, etc.), as well as whether the external energy source 12 is connected or is not connected.

The use of the exemplary embodiments provides in one aspect thereof selectable low-energy boot modes in the battery-powered device 10, making it possible for the user to gain access to some restricted functionality of the device 10 even when the main operating system (OS) cannot execute in a lower-energy (e.g., partially or almost totally discharged battery 10I situation.

The use of these exemplary embodiments enables the user to create, store, and transmit notification messages to recipients even when the main battery 10I has “died” (is fully discharged or nearly or substantially fully discharged). For example, a voice or short message service (SMS) message can be transmitted, the message containing information such as “FYI-Gary wants you to know that his phone battery just died and he is not available until able to charge the phone battery”

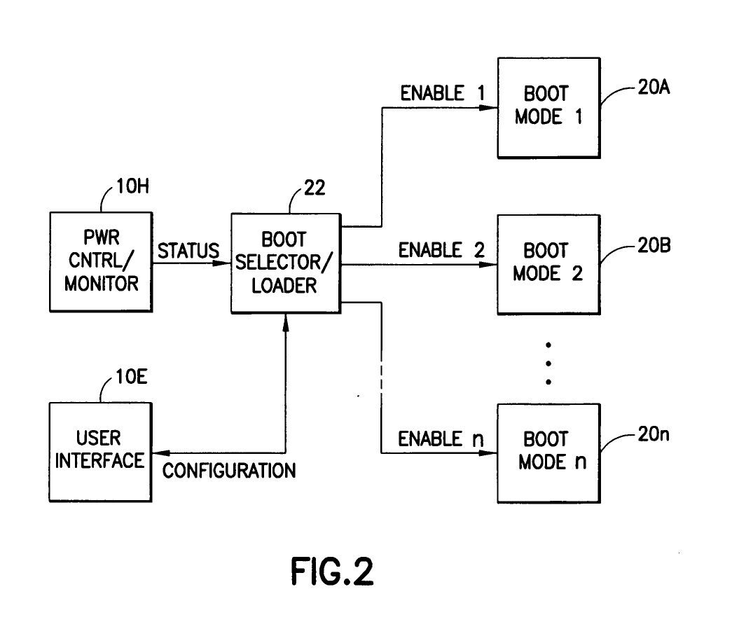

Referring to FIG. 2, an aspect of the exemplary embodiments provides an ability to select one of a plurality of available boot modes at least in part based on the battery charge level and/or the connection status of the external energy source 12 (connected and charging, not connected). FIG. 2 shows a plurality of available boot modes (Boot Mode_{—1, Boot Mode}_2, . . . , Boot Modeₙ) and a boot selector and loader function 22 that enables (via corresponding enable signals) one of the plurality of available boot modes.

As is generally known, a boot loader is the first software program that runs when a computer starts. The boot loader is responsible for loading and transferring control to an operating system kernel software (such as Linux). The kernel, in turn, initializes the remainder of the operating system.

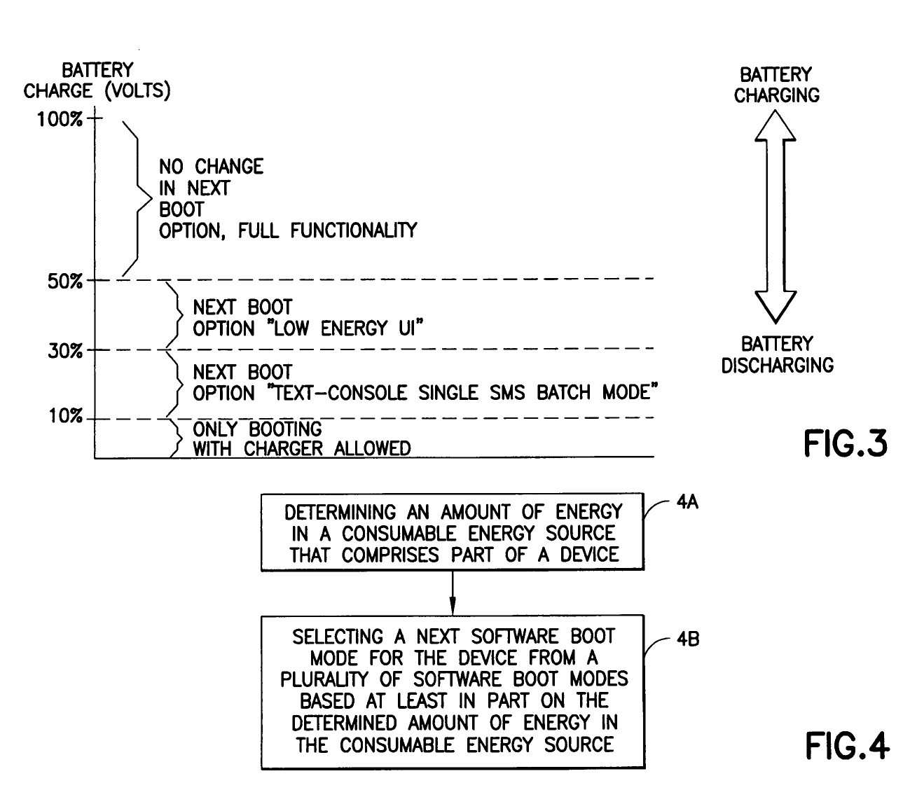

In the exemplary embodiments the boot selector and loader function 22, which may be embodied as part of the program 10C, or as hardware, or as a combination of hardware and software (and possibly firmware), receives the status input from the PWR CNTRL/MONITOR functional block 10H. The boot loader and selector function 22 analyzes the received status signal to make a boot mode filtering and/or selection decision. The boot selector and loader 22 may also interact with the user interface 10E to enable some user configuration of the boot mode selector function and/or user selection of a boot mode as described below. As will become evident below at least during the discussion of FIG. 3, the boot selector and loader function 22 may be implemented as a physical and/or logical state machine having one or more inputs (e.g., battery level and external energy source connection status, and possibly also user-selected configuration information).

As employed herein enabling a boot mode implies an ability to define and/or invoke, load and execute some software program code that places the device 10 into some pre-defined operational state. These operational states may include, as non-limiting examples, normal, fully functional operation with the main (primary) OS, operation with a sub-set of the main OS, operation with a pre-stored default text or multi-media-based message and a communication stack (e.g., a cellular protocol stack) sufficient to at least transmit the message, and operation with a text-based user interface and a communication stack (e.g., a cellular protocol stack) sufficient to at least transmit a user-composed message, such as an SMS message.

Filtering of available boot modes may be based on the available battery charge level and/or charger connection. Selection of the boot mode maybe configured to be automatic and/or user-definable.

As one example, a particular user when in a hurry may be able to connect the device 10 to the external energy source 12 for only 20 seconds instead of for 60 seconds or longer that may be required to boot up to the primary OS (e.g., corresponding to Boot Mode _1 in FIG. 2). A “batch mode” for sending pre-stored notification messages may be automatically initiated upon connecting the device 10 to the external energy source 12 to facilitate shortening the time required to send the notification messages.

The device 10 may be provided with a secondary boot option for quick “batch mode” operation for low-energy conditions. This secondary boot option (e.g., Boot Mode_2) may be used, for example, for reading a notification message from a message buffer, transmitting the notification message to the recipient over a communications link, alerting the user that the message has been successfully sent and, optionally, shutting down the device 10 after all messages in the message buffer have been transmitted. This mode may be operational when there is insufficient energy (charge) for running the primary boot option from the main battery. Additionally or alternatively, a parallel energy source (PES) 10K can be used for this purpose, such as an auxiliary button-sized battery, a supercapacitor, a dynamo, a powered communication interface, a charger or any combination of these.

Additionally or alternatively, the device 10 may be provided with further low energy boot options (e.g., one or more additional low energy boot options up to Boot Modeₙ in FIG. 2) for running software that needs access only to a restricted subset of device 10 resources (such as a simple notification text message editor) with lower energy requirements as compared to other boot options. These low energy boot mode options may be suitable to be powered with, for example, the remaining charge in the main battery 10I and/or the alternative parallel energy source 10K such as the above-mentioned button-size battery, supercapacitor, powered communication interface (e.g. USB or PoE) and/or dynamo.

The various boot options may be provided with access to relevant data from other boot mode options. As one example, the “batch mode” boot option may transmit a message or messages created using another lower-energy boot mode option configured for message creation and/or the primary boot option. Similarly, a low-energy boot option for creating messages may be provided access to stored contact information of the primary boot option (stored in the memory 10B) either by having direct read access (e.g., via shared memory) or by maintaining a mirror phonebook (contact) database for the message-creation boot option (e.g., via replication).

Combinations and/or configurations of the various low-energy boot options may be provided. For example, a combined message creation and message sending boot option may be provided, and/or a combined secondary camera capture and multimedia message service (MMS) sending boot option may be provided. The enabled set of device 10 features/resources may be at least in part user-definable via the user interface 10E. For example, for some particular boot mode operation one user-definable option may be to enable SMS creation and/or recorded voice creation, but to disable MMS and email creation.

One exemplary use case scenario that is enabled by the use of the exemplary embodiments is as follows:

A) The main battery 10I reaches a threshold charge level (e.g., some predefined critical level such as “OEM defined battery critical flag” level as described in “Advanced Configuration and Power Interface Specification” Hewlett-Packard Corporation Intel Corporation Microsoft Corporation Phoenix Technologies Ltd. Toshiba Corporation, Revision 4.0 June 16, (ACPI), or some other level optionally being a user-defined level). As a consequence, the device 10 is shut down after determining and storing a next possible boot mode of a message creation boot mode. In this condition the user may not boot the device 10 in the primary boot mode or the “batch mode” due to the fact that it is determined that the needed energy requirements cannot be supplied by the battery 10I.

B) However, the user may boot the device 10 to the message-creation boot mode that operates with only a lower-power text-based user interface 10E configuration. This configuration may also provide the user access to some sub-set of the contacts database. The user may then compose a notification message such as: “Hello, battery dying, I'm taking the next train.”

C) The user-composed notification message is stored, and the user shuts down the device 10. If desired, the user may be prompted for input regarding the next boot mode before the device 10 shuts down. For example, the user may indicate that if a charger connection is detected, the device 10 should automatically send the stored notification message to the selected recipient and, unless the user would indicate otherwise, an immediate shutdown would follow after an indication to the user of a successful transmission of the message.

D) Later, just before catching the next train, the user gains temporary access to a power outlet for the external energy source 12. When the external energy source 12 is first connected the boot selector and loader 22 of the device 10 automatically boots to the “batch mode”, which checks for the presence of any messages in the message buffer (assumed in this case to be stored in a non-volatile portion of the memory 10B). Upon finding the previously composed and stored notification message, the stored message is retrieved and transmitted automatically (e.g., as a SMS message). If another message or other messages are found in the buffer then they are transmitted as well. The device 10 may then provide some indication (e.g., an audible or tactile indication) of successful message transmission, thereby informing the user that the external energy source 12 can be removed. The display 10F of the user interface 10E may remain blank during this entire process. The user can then disconnect the external energy source 12 and catch the train. Note in this case that the device 10 may be connected to the external energy source 12 for but a few seconds, or just long enough to boot up into the Boot Mode_2 (e.g., the “batch mode”) and transmit the buffered message(s), but not long enough to boot up into the Boot Mode_1 (e.g., to boot the primary OS). Optionally, the user could cancel the message transmission and/or device shutdown after the message transmission, e.g., through a keypress potentially enabling user selection of a desired boot mode. For example, if the user has missed the train but is able to find a charging station, he may wish to prevent message transmission and instead have the device in a fully operational mode thus enabling, e.g., phone calls while recharging.

As should be appreciated, the exemplary embodiments enable, based on the charge state of the battery 10I, and whether the device 10 is connected to an external power source (e.g., to the external energy source 12), for a default next boot level to be automatically selected. The exemplary embodiments enable selecting among a plurality of boot modes based on available charge level/external energy source (e.g., charger) connection status.

For example, and referring to FIG. 3:

the external energy source 12 is not connected (battery 10I is discharging)

a) if the battery level is between 100% and 50%, there is no change in the default next boot option (the default next boot option remains at “full functionality”);
b) if the battery level is below a first threshold (e.g., 50%) and above a second threshold (e.g., 30%), the default next boot option is changed to “low-energy UI”;
c) if the battery level is below the second threshold of 30% and above a third threshold (e.g., 10%), the default next boot option is changed to “text-console single SMS batch-mode with immediate shut down after sending the SMS”; and
d) if the battery level is below the third threshold only booting with the external energy source 12 is allowed, and the default next boot option may be changed to “low-energy UI”. In this case it may also be an option for the user to select as the default next boot option either “full functionality” or “batch mode”.

Note that in all cases, at the time of the next boot the user may be presented the default next boot option as one alternative (e.g., as the automatically starting one if the user does not cancel, for example, by selecting another boot alternative) among a plurality of all possible user-selectable boot options. The plurality of all possible user-selectable boot options presented to the user at boot time comprises the group of all defined boot options, or a subgroup thereof. The subgroup may be selected and/or ordered based at least in part on the battery level at boot time. In other words, while the default next boot option(s) may be dynamically defined based at least in part on battery level at the time before the shutdown preceding the next boot, the actual boot option the user will select at the next boot may differ from those previously defined default boot option(s). There may be several default boot options that may take into account, e.g., the charger connectivity at the boot time.

The user may optionally be presented with an estimate of a maximum time that a particular boot option can operate with the current battery level at boot time. For example, a full functionality boot option may have an associated 1-minute estimate, while a low-energy UI boot option may have an associated 10-minute estimate. In some embodiments, the boot options presented to the user may be configured to be ordered based on the estimate. This information may be derived from battery information (e.g., as described in the ACPI specification with battery status entries) and/or the available energy profile information of various functions associated with the individual boot options. For example, the battery circuitry may indicate some available operation time at some discharge rate X, and simultaneously it may be statistical evidence that the “low-energy UI” boot mode usually causes an average discharge rate Y. The estimated operation time associated with the “low energy UI” boot mode may thus be derived based on X and Y. It is contemplated that the estimates may be dynamically changed over time as the statistics associated with a particular boot mode is collected over time and/or the battery characteristics change. Based on the above, the skilled person would be able to replace the estimated time with an estimate of a number of available high-level operations such as composing and sending an SMS, if such a representation would better reflect the nature of the particular boot mode. If desired, the user might therefore be presented an estimated number N of operations associated with a boot mode, available at the current battery level.

Further by example, and still referring to FIG. 3:

external energy source 12 is connected (battery 10I is charging)

a) if the battery level is below the third threshold only booting with the external energy source 12 is allowed, and the default next boot option may be changed to “low-energy UI” (as above, it may also be an option for the user to select as the next boot option either “full functionality” or “batch mode”); and
b) if the battery level is above the second threshold (or above the first threshold) the default next boot option is changed to “full functionality”.

Note that the threshold levels may be different when the battery 10I is discharging versus when it is charging, thereby providing some potential hysteresis advantages.

In general, whether the external energy source 12 is connected or disconnected can be considered to define a charging state of the consumable energy source (e.g., battery 10I), where the charging state may be either charging (external energy source 12 is connected and providing energy) or discharging (external energy source 12 is not connected, or is connected but is not providing energy (e.g., is not coupled to a power source)). The charging state can be assumed to be reflected in the status signal(s) received by the boot selector/loader function 22 in the FIG. 2.

In general, it can be assumed that the boot selector and loader 22 has knowledge of the battery level thresholds to enable secondary boot modes and filter for available boot modes. For example, the boot selector and loader 22 does not enable the main OS if the first battery level threshold has been reached, but instead may display two other boot modes that are available. Further, if some last possible threshold has been reached (battery 10I is nearly fully discharged), only the text-based “batch mode” with a default message to a default recipient may be activated and the device 10 then automatically shut down.

The use of the exemplary embodiments are advantageous when the user typically completely charges the battery 10I in one charging session, as the user can configure the default next boot option always to be “full functionality” once the external energy source 12 has been connected.

It should be appreciated that the exemplary embodiments provide for the use of different battery threshold levels, with defined next boot options enabled at each threshold and optional shut down at a threshold. Further, at least some of the desired functionality may be user configurable via the user interface 10E. For example, the user might add/remove a threshold at a desired battery level, define the associated default next boot option(s), and further device behavior such as launching an application with parameters (e.g. showing a message template in a messaging application) and/or requesting the device to shut down. Furthermore, the external energy source 12 connection status may also affect the behavior of the boot selector and loader function 22, and not just the absolute battery level.

At least with certain types of operating systems (e.g., Linux) the exemplary embodiments can be implemented as interactions between software entities, such as a battery status logger application and the boot loader configuration, such as modifying the boot loader configuration file at each battery threshold. The exemplary embodiments are also amenable to the use of a hardware interaction, such as with a battery watchdog circuit and/or smart batteries and other power management system components as described, e.g., in the ACPI specification.

As was noted above, combinations and/or configurations of the various low-energy boot options may be provided, for example a combined message creation and sending boot option, or a combined secondary camera capture and MMS sending boot option. The enabled set of device features/resources may be at least in part user-definable.

A non-limiting aspect of these exemplary embodiments is giving the user an ability to define the device behavior including the boot modes in a feature-wise manner. As energy-aware profilers exist for many operating systems, including Symbian, a measure of energy consumption can be indicated per operation (e.g., one SMS/MMS/camera capture, etc.) in association with selection options for the user, or in some other way. For example, the user might define a battery level threshold based on remaining energy sufficient for sending a number N of SMS messages (based on statistical energy profiling of sending one SMS in an analogous manner to the estimated operation time associated with a “low-energy UI” boot mode described above). The user might also define the device to shut down at the threshold with the next boot mode set to, for example, “available charge enables edit and send 2 SMS messages” or the like. In addition, some boot modes can enable launching applications and/or template messages to be sent with the next boot time. In this case the user can, e.g., fill in the actual time of arrival to the otherwise ready message template in the messaging application (and/or scripts/messages could have variable parameters for auto-filling based on context (e.g., recipient, time, and location of boot)). The next boot could optionally be scheduled to occur at a future time, e.g., with the assistance of hardware timer circuitry. Combined with the capability to define the next boot mode, this type of operation enables a generic, power-efficient scheduled task engine with messaging capabilities, operating as a state machine with a battery charge parameter as one of the input state variables.

An estimate can be made of measures needed to generate sufficient energy to execute an operation, for example, an estimated number of dynamo turns needed to send one SMS message. For example, an associated boot mode could then just have enough energy to show the user a screen containing a message “Please wind the dynamo for 100 turns to continue to next screen for editing an SMS. Sending the SMS will require 150 turns more as an estimate—you may generate those now and/or after editing the SMS”.

In general, the use of the exemplary embodiments may arise in at least two different circumstances, e.g., 1) when running some boot option and 2) when booting up. In the first circumstance some event can occur with respect to a default next boot mode, automatically, and based at least in part on rules associated with various thresholds. In the second circumstance the user may indeed allow the default boot mode to initiate, but not necessarily. For example, a GRUB boot loader provides a command line environment for the user to work with.

More specifically, GNU GRUB (short for GNU GR and Unified Bootloader) is a boot loader package from the GNU Project. GRUB (shortened form of GNU GRUB) is a reference implementation of a Multiboot Specification, which enables a user to have multiple operating systems on their computer, and choose which one to run when the computer starts. GRUB can be used to select from different kernel images available on a particular operating system's partitions, as well as to pass boot-time parameters to such kernels. GNU GRUB can load a wide variety of free operating systems, as well as proprietary operating systems with chain-loading. GRUB understands file systems and kernel executable formats, enabling the user to load the kernel simply by specifying its file name and the drive and partition where the kernel resides. When booting with GRUB the user can employ either a command-line interface or a menu interface. Using the command-line interface the user types the drive specification and file name of the kernel manually. In the menu interface (based on a user modifiable configuration file) the user selects an OS using arrow keys.

Further in accordance with the exemplary embodiments, and as an alternative to the default boot mode during an occurrence of the first circumstance, the user may select from a plurality of possible boot modes based on, for example, configuration file(s) stored at a known location and/or real-time information with respect to the battery/charger status during the occurrence of the second circumstance.

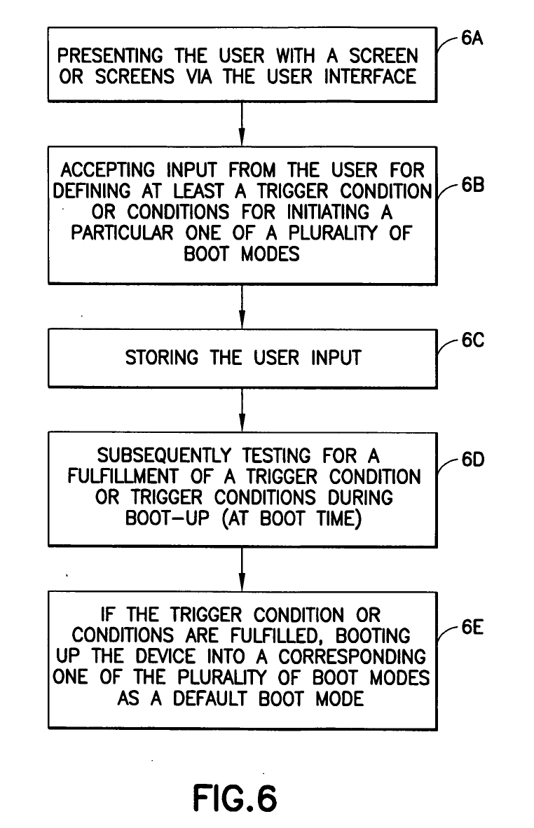

Referring to FIG. 5, an aspect of the exemplary embodiments is a method to facilitate selection of a next default boot mode when the device 10 is in a running state. This mode of operation can comprise (Block 5A), presenting the user with a screen or screens via the user interface 10E, (Block 5B) accepting input from the user for defining at least a trigger condition or conditions for initiating a particular one of a plurality of boot modes, (Block 5C) storing the user input, (Block 5D) subsequently testing for a fulfillment of a trigger condition or trigger conditions during operation of the device 10 and, (Block 5E) if the trigger condition or conditions are fulfilled, initiating a corresponding one of the plurality of boot modes as a default boot mode.

It should be noted that a separate software module may be needed for each boot mode or boot option (e.g., one particular OS boot option may not be compatible with another OS boot option). However, in some embodiments the same code may be accessible and/or compatible with several or all boot options.

Referring to FIG. 6, a further aspect of the exemplary embodiments is a method to facilitate selection of a next default boot mode when the device 10 is in a boot-up state (at boot time). This mode of operation can comprise (Block 6A), presenting the user with a screen or screens via the user interface 10E, (Block 6B) accepting input from the user for defining at least a trigger condition or conditions for initiating a particular one of a plurality of boot modes, (Block 6C) storing the user input, (Block 6D) subsequently testing for a fulfillment of a trigger condition or trigger conditions during boot-up (at boot time) and, (Block 6E) if the trigger condition or conditions are fulfilled, booting up the device into a corresponding one of the plurality of boot modes as a default boot mode.

Note in this latter embodiment that there may be a single software module that can be integrated with the boot selector/loader module 22, as opposed to using multiple software modules.

Based on the foregoing it should be apparent that the exemplary embodiments provide a method, apparatus and computer program(s) to enhance the energy management and utilization in a (portable) device powered by a consumable energy source.

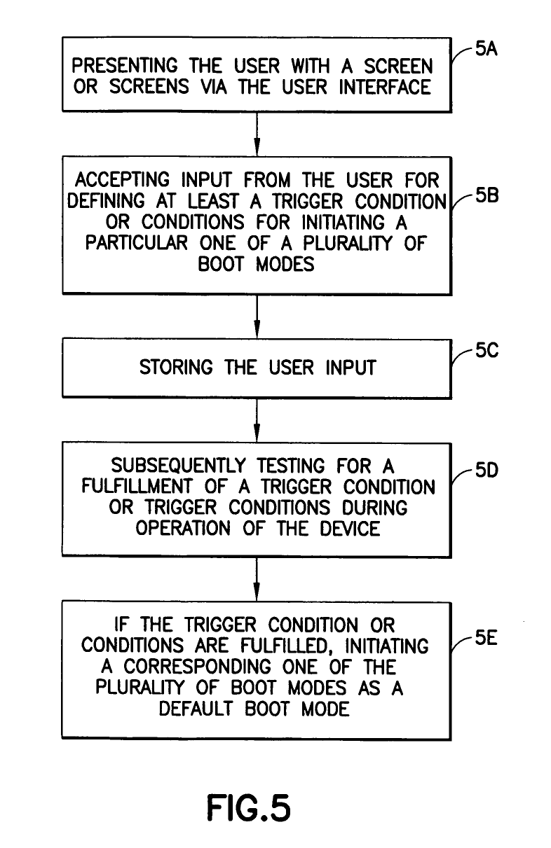

FIG. 4 is a logic flow diagram that illustrates the operation of a method, and a result of execution of computer program instructions, in accordance with the exemplary embodiments. In accordance with these exemplary embodiments a method performs, at Block 4A, a step of determining an amount of energy in a consumable energy source that comprises part of a device. At Block 4B there is a step of facilitating selection of a next software boot mode for the device from a plurality of possible software boot modes based at least in part on the determined amount of energy in the consumable energy source.

In the method as explained in the preceding paragraph, where facilitating selection further considers at least one user-configurable boot option.

In the method depicted in FIG. 4, where the consumable energy source is comprised of a battery, and where facilitating selection considers whether an energy source external to the device is connected to the device.

In the method depicted in FIG. 4, where a default next software boot mode is a full functionality operating system boot mode when the amount of energy in the consumable energy source is greater than a first threshold.

In the method as explained in the preceding paragraph, where a default next software boot mode is a lower energy boot mode when the amount of energy in the consumable energy source is less than the first threshold and greater than a second threshold, and where the lower energy boot mode is configured to permit a user to create and transmit at least one message from the device.

The at least one message can be, for example, one of a short message service text message, an e-mail message, an instant message, an enhanced messaging service (EMS) or similar message, or a multi-media message comprising at least one of image and audio content.

In the method depicted in FIG. 4, where selection of a default next software boot mode is facilitated when executing a boot option, and occurs automatically based on a rules set associated at least with a plurality of energy thresholds.

In the method depicted in FIG. 4, where selection of a default next software boot mode is facilitated during a boot-up operation, where the selection is facilitated by at least one of a user-selectable boot mode configuration; and a current status of the amount of energy in the consumable energy source and a charging state of the consumable energy source.

In the method depicted in FIG. 4, where facilitating selection further considers at least one user-configurable boot option, and further comprising providing a user at boot-up time with a plurality of user-selectable boot options comprising a set of all available boot options or a subset of all available boot options, where the provided user-selectable boot options are determined at least in part by the determined amount of energy in the consumable energy source at boot-up time.

In the method depicted in FIG. 4, where facilitating selection further considers at least an estimate of a maximum amount of operation time remaining for a particular boot mode, the estimate being based at least in part on a current determination of the amount of energy in the consumable energy source at boot-up time; and an estimate of a number of operations a particular boot mode is capable of performing, the estimate being based at least in part on a current determination of the amount of energy in the consumable energy source at boot-up time.

In the method depicted in FIG. 4, where facilitating selection further comprises enabling a user to define and configure device behavior including at least one of boot modes and an operation or operations to be performed when executing a certain boot mode; boot modes and an application or applications to be launched when executing a certain boot mode; and energy threshold levels associated with the consumable energy source and, for each energy threshold, a default boot mode for that energy threshold.

The various blocks shown in FIG. 4 may be viewed as method steps, and/or as operations that result from operation of computer program code, and/or as a plurality of coupled logic circuit elements constructed to carry out the associated function(s).

The exemplary embodiments also encompass an apparatus that comprises a processor; and a memory including computer program code. The memory and computer program code are configured to, with the processor, cause the apparatus at least to perform determining an amount of energy in the consumable energy source; and facilitating selection of a next software boot mode from a plurality of possible software boot modes based at least in part on the determined amount of energy in the consumable energy source.

The exemplary embodiments also encompass an apparatus that comprises means for determining an amount of energy in a consumable energy source of a communications device; and means for facilitating selection of a next software boot mode for the communications device from a plurality of possible software boot modes based at least in part on the determined amount of energy in the consumable energy source.

The exemplary embodiments also pertain to a computer-readable memory medium that stores a program comprised of software instructions that when executed by at least one data processor result in performing operations that comprise determining an amount of energy in a consumable energy source that comprises part of a device; and facilitating selection of a next software boot mode for the device from a plurality of possible software boot modes based at least in part on the determined amount of energy in the consumable energy source.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments may be illustrated and described as block diagrams, flow charts, or using some other pictorial representation, it is well understood that these blocks, apparatus, systems, techniques or methods described herein maybe implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments may be realized in an apparatus that is embodied as an integrated circuit. The integrated circuit or circuits may comprise circuitry (as well as possibly firmware) for embodying at least one or more of a data processor or data processors, a digital signal processor or processors, baseband circuitry, radio frequency circuitry and power management/monitoring circuitry that are configurable so as to operate in accordance with the exemplary embodiments.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

For example, while the exemplary embodiments have been described above in the context of various message types (e.g., EMS, MMS, SMS) it should be appreciated that the exemplary embodiments are not limited for use with only these particular message types. For example, and as was noted above, electronic mail (e-mail) messages may be composed/sent, as can instant messaging messages, as two additional non-limiting embodiments.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters are not intended to be limiting in any respect, as these parameters may be identified by any suitable names. Further, various battery charge thresholds considered by the boot selector/loader 22 may differ from those expressly disclosed herein. Further, the various names assigned to different elements and functions are not intended to be limiting in any respect, as these various elements and functions may be identified by any suitable names. Further still, these exemplary embodiments of the invention are not constrained for use with only the various operating system types mentioned above, nor with only those types of consumable energy sources and/or parallel (auxiliary) energy sources and/or external energy sources mentioned above.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

What is claimed is:

1. A method comprising:
determining an amount of energy in a consumable energy source of a device; and
facilitating selection of a next software boot mode for the device from a plurality of software boot modes based at least in part on the determined amount of energy in the consumable energy source.

2. The method of claim 1, where facilitating selection further considers at least one user-configurable boot option.

3. The method of claim 1, where the consumable energy source is comprised of a battery, and where facilitating selection considers whether an energy source external to the device is connected to the device.

4. The method of claim 1, where a default next software boot mode is a full functionality operating system boot mode if the amount of energy in the consumable energy source is greater than a first threshold.

5. The method of claim 4, where a default next software boot mode is a lower energy boot mode if the amount of energy in the consumable energy source is less than the first threshold and greater than a second threshold, and where the lower energy boot mode is configured to permit a user to create and transmit at least one message from the device.

6. The method of claim 1, where selection of a default next software boot mode is facilitated when executing a boot option, and occurs automatically based on set of rules associated at least with a plurality of energy thresholds.

7. The method of claim 1, where selection of a default next software boot mode is facilitated during a boot-up operation, where the selection is facilitated by at least one of:
a user-selectable boot mode configuration; and
a current status of the amount of energy in the consumable energy source and a charging state of the consumable energy source.

8. The method of claim 1, where facilitating selection further considers at least one user-configurable boot option, and further comprising providing a user at boot-up time with a plurality of user-selectable boot options comprising a set of all available boot options or a subset of all available boot options, where the provided user-selectable boot options are determined at least in part by the determined amount of energy in the consumable energy source at boot-up time.

9. The method of claim 1, where facilitating selection further considers at least one user-configurable boot option, and further comprising providing a user with at least one of:
an estimate of a maximum amount of operation time remaining for a particular boot mode, the estimate being based at least in part on a current determination of the amount of energy in the consumable energy source at boot-up time; and
an estimate of a number of operations a particular boot mode is capable of performing, the estimate being based at least in part on a current determination of the amount of energy in the consumable energy source at boot-up time.

10. The method of claim 1, where facilitating selection further comprises enabling a user to define and configure device behavior comprising at least one of:
boot modes and an operation or operations to be performed while executing a certain boot mode;
boot modes and an application or applications to be launched while executing a certain boot mode; and
energy threshold levels associated with the consumable energy source and, for each energy threshold, a default boot mode for that energy threshold.

11. An apparatus comprising:
at least one processor; and
at least one memory including computer program code, the at least one memory and the computer program code configured to, with the at least one processor, cause the apparatus at least to perform:
determine an amount of energy in a consumable energy source of a device; and
facilitate selection of a next software boot mode for the device from a plurality of software boot modes based at least in part on the determined amount of energy in the consumable energy source.

12. The apparatus of claim 11, where facilitating selection further considers at least one user-configurable boot option.

13. The apparatus of claim 11, where the consumable energy source is comprised of a battery, and where facilitating selection considers whether an energy source external to the device is connected to the device.

14. The apparatus of claim 11, where a default next software boot mode is a full functionality operating system boot mode if the amount of energy in the consumable energy source is greater than a first threshold.

15. The apparatus of claim 14, where a default next software boot mode is a lower energy boot mode if the amount of energy in the consumable energy source is less than the first threshold and greater than a second threshold, and where the lower energy boot mode is configured to permit a user to create and transmit at least one message from the device.

16. The apparatus of claim 11, where selection of a default next software boot mode is facilitated when executing a boot option, and occurs automatically based on set of rules associated at least with a plurality of energy thresholds.

17. The apparatus of claim 11, where selection of a default next software boot mode is facilitated during a boot-up operation, where the selection is facilitated by at least one of:
a user-selectable boot mode configuration; and
a current status of the amount of energy in the consumable energy source and a charging state of the consumable energy source.

18. The apparatus of claim 11, where facilitating selection further considers at least one user-configurable boot option, and further comprising providing a user at boot-up time with a plurality of user-selectable boot options comprising a set of all available boot options or a subset of all available boot options, where the provided user-selectable boot options are determined at least in part by the determined amount of energy in the consumable energy source at boot-up time.

19. The apparatus of claim 11, where facilitating selection further considers at least one user-configurable boot option, and further comprising providing a user with at least one of:
an estimate of a maximum amount of operation time remaining for a particular boot mode, the estimate being based at least in part on a current determination of the amount of energy in the consumable energy source at boot-up time; and
an estimate of a number of operations a particular boot mode is capable of performing, the estimate being based at least in part on a current determination of the amount of energy in the consumable energy source at boot-up time.

20. The apparatus of claim 11, where facilitating selection further comprises enabling a user to define and configure device behavior comprising at least one of:
boot modes and an operation or operations to be performed while executing a certain boot mode;
boot modes and an application or applications to be launched while executing a certain boot mode; and
energy threshold levels associated with the consumable energy source and, for each energy threshold, a default boot mode for that energy threshold.

21. A computer-readable memory medium that stores computer program instructions, the execution of the computer program instructions by at least one data processor results in a performance of operations that comprise:
determining an amount of energy in a consumable energy source of a device; and
facilitating selection of a next software boot mode for the device from a plurality of software boot modes based at least in part on the determined amount of energy in the consumable energy source.

22. The computer-readable memory medium of claim 21, where facilitating selection further considers at least one user-configurable boot option.

23. The computer-readable memory medium of claim 21, where the consumable energy source is comprised of a battery, and where facilitating selection considers whether an energy source external to the device is connected to the device.

24. The computer-readable memory medium of claim 21, where a default next software boot mode is a full functionality operating system boot mode if the amount of energy in the consumable energy source is greater than a first threshold, and where a default next software boot mode is a lower energy boot mode if the amount of energy in the consumable energy source is less than the first threshold and greater than a second threshold, and where the lower energy boot mode is configured to permit a user to create and transmit at least one message from the device.

25. The computer-readable memory medium of claim 21, where selection of a default next software boot mode is facilitated when executing a boot option, and occurs automatically based on set of rules associated at least with a plurality of energy thresholds.

26. The computer-readable memory medium of claim 21, where selection of a default next software boot mode is facilitated during a boot-up operation, where the selection is facilitated by at least one of:
a user-selectable boot mode configuration; and
a current status of the amount of energy in the consumable energy source and a charging state of the consumable energy source.

27. The computer-readable memory medium of claim 21, where facilitating selection further considers at least one user-configurable boot option, and further comprising providing a user at boot-up time with a plurality of user-selectable boot options comprising a set of all available boot options or a subset of all available boot options, where the provided user-selectable boot options are determined at least in part by the determined amount of energy in the consumable energy source at boot-up time.

28. The computer-readable memory medium of claim 21, where facilitating selection further considers at least one user-configurable boot option, and further comprising providing a user with at least one of:
an estimate of a maximum amount of operation time remaining for a particular boot mode, the estimate being based at least in part on a current determination of the amount of energy in the consumable energy source at boot-up time; and
an estimate of a number of operations a particular boot mode is capable of performing, the estimate being based at least in part on a current determination of the amount of energy in the consumable energy source at boot-up time.

29. The computer-readable memory medium of claim 21, where facilitating selection further comprises enabling a user to define and configure device behavior comprising at least one of:
boot modes and an operation or operations to be performed while executing a certain boot mode;
boot modes and an application or applications to be launched while executing a certain boot mode; and
energy threshold levels associated with the consumable energy source and, for each energy threshold, a default boot mode for that energy threshold.
